(19) United States
(12) Patent Application Publication
(10) Pub. No.: US 2003/0098276 A1
(43) Pub. Date: May 29, 2003

(54) Filter for removing bacteria and particulates from fluid stream

(76) Inventor: Robert A. Carlson, Lake Bluff, IL (US)

Correspondence Address: LADAS & PARRY, 224 SOUTH MICHIGAN AVENUE, SUITE 1200, CHICAGO, IL, 60604, US

(21) Appl. No.: 10/190,983

(22) Filed: Jul. 8, 2002

Related U.S. Application Data
(63) Continuation-in-part of application No. PCT/US02/08998, filed on Mar. 22, 2002.
(60) Provisional application No. 60/304,370, filed on Jul. 10, 2001.

(51) Int. Cl. B01D 29/07; B01D 29/11

(52) U.S. Cl. 210/497.1

(57) ABSTRACT

A fluid filter and a method of filtering flowing fluid so as to remove undesirable particulates and bacterial constituents, the method comprising providing an enclosed channel for fluid flow and passing the fluid flow through a filter material, disposed within the channel and in the fluid flow path, the filter material comprising a metal alloy consisting primarily copper and zinc and further comprising a metal fiber wool consisting of metal fibers having an average diameter from 12 microns to 150 microns, contact of the fluid with the fibers of the metal fiber wool providing a bactericide effect and inhibiting further propagation of bacteria and particulates from flowing through the filter material. In a radial-flow filter comprising multi-perforate pipe and a plurality of overlapping layers of strip of fibrous metal wool includes metal wool containing copper (Cu). The a multi-perforate shell may have an inner diameter approximately equal to the outer diameter of the outermost layer of wool and a tubular metal mesh encompassing the exterior of the pipe between the pipe and the innermost layer of metal wool, the tubular mesh being a woven mesh of stainless steel. The metal of the fiber wool layers is a brass alloy having between 50 to 90 weight % copper and from 10 to 50 weight % zinc, a preferable density in a range between 0.4 g/cm³ to 2.5 g/cm³, a more preferred density in a range between 0.5 g/cm³ and about 1.5 g/cm³ and a most preferred density approximately 0.8 g/cm³.

### CROSS-REFERENCE TO RELATED APPLICATIONS

This is filed as a non-provisional application of U.S. Provisional Application No. 60/304,370 filed on Jul. 10, 2001, and a continuation in part of commonly owned PCT Application No. PCT/US02/08998, filed on Mar. 22, 2002.

### BACKGROUND OF THE INVENTION

1. Field of the Invention

The present invention relates generally to industrial production coolant systems and situations where water and/or water oil emulsions need to be filtered in a recirculating system, and more particularly to means for reducing bacteria and other particulate matter from a recirculating fluid.

2. Background Art

It has been demonstrated that the technology disclosed in U.S. Pat. No. 5,833,853 provides a level of filtration that effectively blocks particulates from passing through a filter such that the filter does not clog, plug or otherwise reduce the flow of fluid through the filter. The manufacturing process described in that patent includes the steps of spirally winding a metallic wool around a perforated tube, under pressure, and lapping the wool at an acute angle to form a barrier to the particles one wishes to block with the filter. Experiments have shown the metallic wool can have a fiber diameter in a range of from 12 microns to 150 microns. Finer wools are preferably utilized to filter finer particulate matter. Similar types of filters, comprising randomly aligned layers of metal fiber wool mats are disclosed in commonly owned PCT Patent Application No. PCT/US02/08998. The disclosures of both PCT Application No. PCT/US02/08998 and of commonly owned U.S. Pat. No. 5,833,853 are incorporated herein by reference.

A number of factors affect the filtering efficiency and capacity, such as the fiber diameter, the amount of compaction and the thickness of the wound fiber, the filtration particle size and the rate of flow of the effluent through the filter. One unique result is the ability of the filter to continue to operate in conditions where other conventional filters have plugged and ceased to operate effectively. This is due to the very high level of openness available in the random matrix structure of wound metallic wool, in general, and in the unique characteristics of the manufacturing process and end product filters made in accordance with the aforementioned U.S. Pat. No. 5,833,853.

Filters are often used in machining and grinding centers where a liquid coolant is directed in a steady stream to cool the work and cutting tool. This coolant usually comprises water with a small amount of oil in an emulsified state or oil. After lubricant is directed against the part being worked, the coolant flows down and is collected in a sump and is then drawn through a filter and reused.

Metallic wool filters made according to the aforementioned patented method have been shown to very effectively filter out small metal chips, other particulates and debris. Moreover, these filters last far longer than the normal filters used in such service, thus extending the operating cycle of the machining center without encountering significant downtime for maintenance of the filter.

With the machining centers mentioned above, it is known that bacteria present in coolant fluids used in metal working machines cause a number of problems, including disagreeable odors, loss of functionality of the fluid and occasionally medical problems of the machine operators. The bacteria are believed to thrive in such an environment due to the warmth of the working environment and the frictional heat generated by the machining or grinding processes. Conditions are often prevalent in which coolant sometimes sits weekends or other long periods of downtime that permit bacteria to flourish. The bacteria have been known to cause noxious odors and in some cases dermatological problems of the workers.

A variety of antimicrobial treatments have been used to combat this problem, with varying degrees of success. In order to mitigate the bacteria, it has been normal practice to treat the coolant with bactericidal chemicals to kill the bacteria.

The toxicity of heavy metals, such as brass, has been found to attenuate the bacterial numbers present in the coolant. Brass in the form of chips has been incorporated into a bed, and the coolant is repeatedly pumped through this bed as the fluid is being used.

In U.S. Pat. Nos. 5,198,118, 5,599,459, and 5,833,859 the use of metallic particulate chips, such as copper or brass chips, is proposed to reduce the bacteria count in a water system, for example, in drinking water. These brass chips in the form of a bed, however, do not provide any type of filtering capability to remove metallic chips and other solid particulates from a recirculating fluid, which function must be provided, if desirable, by a separate filter in the fluid stream.

Thus, what is needed is a filter capable of providing both functions, that is, both filtering out of a fluid stream solid particulates down to a minimum size and also counteracting the spread and propagation of undesirable bacteria in the recirculating fluid.

### SUMMARY OF THE INVENTION

Thus what is disclosed and claimed herein is a method of filtering flowing fluid containing undesirable particulates and bacterial constituents so as to remove the particulates and reduce the bacterial constituents therefrom comprising a step of providing an enclosed channel for the fluid to flow therethrough and a step of passing the fluid flow through a filter material, disposed within the channel and in the path of the fluid flow, wherein the filter material comprises a metal alloy consisting primarily copper and zinc, and the material further comprises a metal fiber wool consisting of metal fibers having an average diameter in a range of from 12 microns to 150 microns, whereby the fluid containing the bacterial constituents contacting with the fibers of the metal fiber wool provides a bactericide effect and further inhibits the propagation of bacteria and inhibits particulates from flowing through the filter material.

Also disclosed and claimed is a radial-flow fluid filter having a production tubing of a predetermined outer diameter D1, comprising a length L of multi-perforate pipe being much larger than D1, the multi-perforate pipe having an outer diameter corresponding to the diameter of a surrounding filter housing, a plurality of overlapping layers of at least one strip of fibrous metal filter wool wound around the exterior of the length L of multi-perforate pipe, so that adjacent layers are aligned with each other, the metal filter wool comprising a metal containing copper (Cu), and a multi-perforate tubular shell fitting tightly around the outermost layer of the copper containing fibrous metal wool. In a preferred embodiment, the a multi-perforate shell disposed around the outermost layer of metal wool has a shell with an inner diameter approximately equal to the outer diameter D2 of the outermost layer of wool and a tubular metal mesh encompassing the exterior of the pipe between the pipe and the innermost layer of metal wool, the tubular mesh being a woven mesh of stainless steel. The metal of the fiber wool layers is a brass alloy further comprising between 50 to 90 weight % copper and from 10 to 50 weight % zinc, and has a preferable density in a range between 0.4 g/cm³ to 2.5 g/cm³, a more preferred density in a range between 0.5 g/cm³ and about 1.5 g/cm³ and a most preferred density approximately 0.8 g/cm³.

### BRIEF DESCRIPTION OF THE DRAWINGS

FIG. 1 is a cross-sectional view of a filter made in accordance with a first embodiment of the invention.

FIG. 2 is a cross-sectional view of another embodiment of the invention; and

FIG. 3 is a cross-sectional view of yet another embodiment of the invention.

### DETAILED DESCRIPTION OF THE PREFERRED EMBODIMENTS

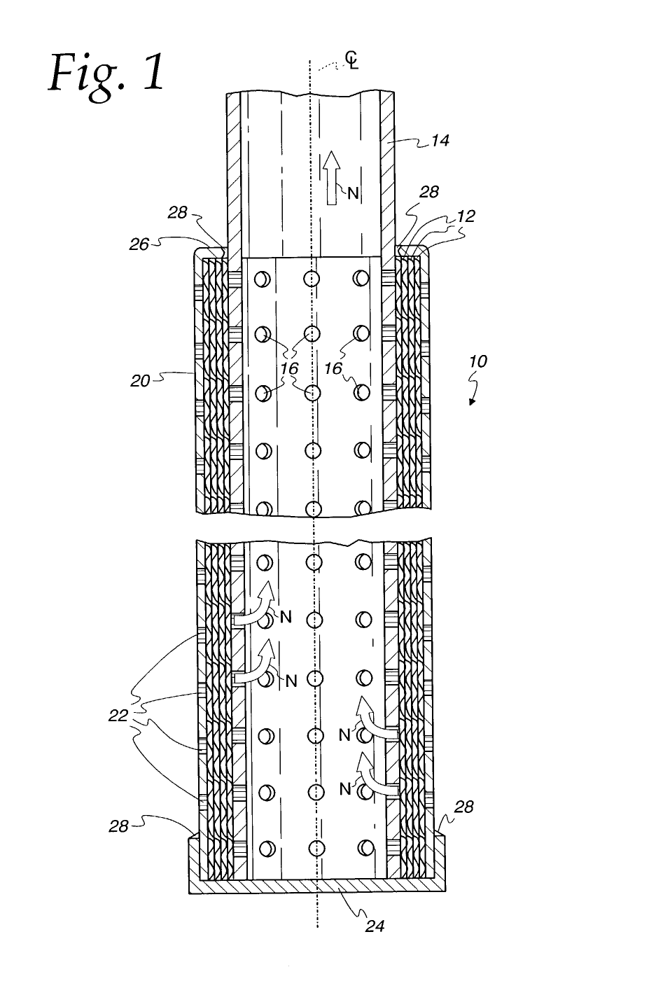

One industrial application for filters according to the present invention is for use in the above described machining and grinding centers where liquid coolant is left stagnant for periods of time, thereby fostering the generation of bacteria. In order to deal with the bacteria problem, filters were wound with a metal wool according to the present invention, preferably a metal wool comprising a majority portion of brass (copper-zinc alloy) with trace or minimal other additive metals or active chemicals. The coolant is drawn through the metal fiber wound filter 10, as shown in FIG. 1, with the result that the bacteria level is dramatically reduced. The metal wool material may take various forms, but the metal fiber wool windings 12 of filter 10 can comprise metal fibers having a fiber diameter of 12 microns to 150 microns.

The metal fiber wool strands are preferably wound on an inner perforated tube 14, having perforations 16, in accordance with the teachings of aforementioned commonly owned U.S. Pat. No. 5,833,853, as shown, that is designed to fit into the machining center filter system (not shown). Alternatively, the metal fiber wool may comprise a wound mat (not shown) that is directly wound onto a perforated pipe, as is described in aforementioned PCT Application No. PCT/US02/08998. A second outer perforated tube 20 may be optionally placed over the inner perforated tube 14 and over wound metal fiber wool windings 12 to provide mechanical protection to the wound wool fibers, and to maintain the metal wool fibers in proper compression.

The metal comprising fiber windings 12 is preferably brass, that is, an alloy of copper and zinc and can contain 50 to 90% copper with the balance zinc, and optionally together with other trace metals. It is desirable to use lead free brass wool in the filters in order to reduce any possible lead contamination and so the filters may be utilized also in a drinking water filtration application.

As in the aforementioned commonly owned U.S. Pat. No. 5,833,853 and PCT Application No. PCT/US02/08998, the outer perforated tube includes outer perforations 22 for contaminated fluid inflow, an end cap 214 and an enclosing flange 26, which may be bent from the opposite end of tube 20 from the cap 24 toward the inner perforated tube 14. The outer tube 20 is attached to the inner tube 14 by an appropriate means, such as welding or spot welding 28, and the end cap 24 is also attached to the outer surface of tube 20 by welding 28. In most respects, except for the composition of the metal fiber wool windings 12, the construction of the filter 10 is essentially identical to those of the aforementioned patent or application.

Another application for a brass wool metallic filter is for filtering the water in cooling towers and in refrigeration and air conditioner systems. Cooling towers operate in the open in heat and weather. The accumulation of bacteria in cooling tower water can render them ineffective in a short time if nothing is done to control the bacteria. The metal wool filter disclosed in U.S. Pat. No. 5,833,853 when wound with a brass wool, not only is effective in removing particulate debris from the cooling water, but also effectively reduces the bacteria level without the need for chemical treatments.

Investigation of the effect on bacterial count of using brass wool as a filter medium has produced surprising results, especially when measuring specific bacterial varieties. The efficacy of reducing bacteria is easily recognizable from data of multiple passes of fluid through a metal or brass fiber wool filters, which is the normal method of utilization of the fluid, as described above. That is, since most of the fluid in the system applications will be recirculating, the fluid will necessarily experience continuous and multiple passes through the filter in normal use.

The field samples of bacteria are taken after each pass and cultured on a plate. The bacterial numbers on the field samples were estimated by performing a standard plate count test and the results forwarded to AMFI. In addition, bacteria varieties will be investigated to a greater degree to determine the types of bacteria which the inventive filtering device and method has the greatest effect.

While laboratory investigation has been limited to attempting to estimate the effectiveness of the treatment by filtering discreet aliquots of samples of coolant fluid containing the “normal” bacterial flora, it is expected that additional testing may uncover modifications and substitutions in the composition of the metallic fiber material of the fibers used in the filters. For example, while brass wool filters were tested, it is contemplated that small or even trace amounts of other metal constituents, for example antimony, may prove to make the filters capable of reducing or eliminating, upon multiple passes, other types of bacteria which may not be possible for filters made from copper or brass wool fibers.

The following bacteria count results were developed in a test environment, but it is expected that similar results would be developed in an industrial or cooling environment. Fiber filters were constructed so as to fit into existing filtering apparatus. A coolant fluid sample was filtered in a step-wise manner and the bacterial numbers estimated after each filtering step. The results of initial laboratory analysis are shown in the table below.

| No. of Passes | Aerobic Plate Count | Reduction in percent (%) |
|---|---|---|
| Through filter | (cfu/ml) | of previous pass |
| 0 | 7250 | — |
| 1 | 6870 | 8.64 |
| 2 | 6150 | 10.5 |
| 3 | 5790 | 5.85 |
| 4 | 5030 | 13.1 |
| 5 | 4610 | 8.35 |
| 6 | 4080 | 9.33 |
| 7 | 3600 | 11.8 |
| 8 | 3070 | 14.7 |
| 9 | 2590 | 15.6 |
| 10 | 2150 | 17.0 |

Although incomplete removal of bacteria is shown, the data shows the apparent reduction microbial numbers on the cooling fluid. The field samples have typically shown significant numbers of bacteria present. Most samples have been in the range of 1.0-6.0×10⁴ colony forming units per milliliter.

In checking for bacterial variety on the field samples, a remarkable lack of diversity on treated samples has been observed. Most samples show only 2-3 types of bacteria present. Most of the bacteria present appear to be of the genus Pseudomonas. Other related genera have been observed. To date, no observations indicate the presence of bacteria commonly associated with water-related health issues such as E. coli (or other coliforms). The presence of substantial numbers of Staphylococcus aureus is not indicated. With a few samples, it has been observed that the presence of spore-forming bacteria, in low numbers survive passes through the filter. The spore-formers seem to appear only when no other bacteria are present, possibly indicating the metal working process, or fluid used in the process is different and may select for the presence of spore-formers.

Laboratory results tend to support these observations. Along with the decrease in bacterial numbers seen in the table, a decrease in the diversity of the organisms present was indicated. Several (10-15) different bacterial colony types were observed in the untreated sample, where only 2-3 types were seen in the samples at the end of the experiment (ten filter passes). The most likely explanation for this is that the metal treatment is effective against some bacteria and less effective against others. As the fluid is treated with the metal, the bacteria that are more resistant to the treatment remain, and may even increase in numbers over time.

The embodiments of filters 10, 120 and 122 also provide significant additional benefits because of its structure. Because of the fine thread construction of the metal fibers, the surface area of the metal exposed to the passing fluid far exceeds the surface area to volume ratio of the prior art chip type microbial treatment systems, for example, that described and illustrated in aforementioned U.S. Pat. No. 5,198,118, which require a significantly greater amount of volume, and thus, of weight of the brass or other metal chips to produce the same anti-microbial effect as the filter material made according to the present invention. The ability to provide the bacteriocidal function in less volume provides several benefits, including the cost reduction in the procurement of metal, the reduced volume requirements permitting better in-line placement of a circulating fluid, easier replacement procedures, etc.

Another significant advantage, not provided by the prior art systems, is the ability to also filter out particulate chips or other solid impurities that may become entrained in the recirculating fluid, thereby omitting the need for a separate filtering mechanism. This inventive type of filter 10, 120,122 is especially useful in applications in which solid particulates are naturally expected, for example, in an industrial application for cooling fluid in a milling machine where metallic chips are entrained in the fluid, or an air conditioning system, in which the cooling fluid is exposed to the elements and can attract solid particulates, such as insects.

The ability to filter solid particulates of various sizes by the inventive device has been established by testing using filter material made according to the present invention under controlled conditions and utilizing known efficiency standards, for example ASTMF 795. In most cases, filter materials having a filter wall thickness of between 0.25″ to 0.75″ in various fluid materials, for example, water and H 5606 oil, flowing at different rates, and having solid particulates of different sizes entrained therein.

In the majority of cases for a single flow through, each of the inventive filters showed a filtering efficiency of over 50% for particles having a diameter between 10 and 100 microns, with the filtering efficiency for particles over 30 microns being close to 100%. The following table shows the filtering efficiency of three separate filters, two of which are made in accordance with this invention, indicating the ability to produce filters having a significant filtering efficiency. The particulates that were injected into the fluids as contaminants were generally a sieved test dust with ceramic spheres.

Particles/100 ml at: (in microns)

| | Net DP, | | | | | | | | |
|---|---|---|---|---|---|---|---|---|---|
| Sample | psid | Port | 40-50 | 50-60 | 60-70 | 70-80 | 80-90 | 90-100 | <100 |
| 2″ Steel | 0.4 | Upstream | 12095 | 7411 | 5028 | 3232 | 2017 | 1141 | 1141 |
| | | Downstream | 4302 | 2162 | 1201 | 591 | 288 | 153 | 80 |
| | | Efficiency | 64.4 | 70.8 | 76.1 | 81.7 | 85.7 | 86.6 | 93.0 |

Note:
2″ dia. steel filter is not straight-possible seal leak due to that feature.

| | Net DP, | | | | | | | | |
|---|---|---|---|---|---|---|---|---|---|
| Sample | psid | Port | 10-20 | 20-30 | 30-40 | 40-50 | 50-60 | 60-70 | <70 |
| 2″ Brass | 0.7 | Upstream | 76067 | 12423 | 5250 | 2647 | 1579 | 956 | 1157 |
| | | Downstream | 36629 | 1712 | 174 | 28 | 6 | 0 | 0 |
| | | Efficiency | 51.8 | 86.29 | 96.7 | 98.9 | 99.6 | <99.9 | <99.9 |
| 2.5″ Brass | 0.4 | Upstream | 85673 | 13990 | 6152 | 3147 | 1783 | 1081 | 1312 |
| | | Downstream | 35106 | 1397 | 69 | 2 | 1 | 1 | 0 |
| | | Efficiency | 59.0 | 90.0 | 98.9 | 99.9 | 99.9 | 99.9 | <99.9 |

Tests were also performed in a recirculating fluid stream to text for solid particulate filtration efficiency, and unexpected results were obtained that showed good filtration and also, as indicated above, simultaneously provided a bacteriocidal capacity. The filtration results, showing the number of solid particulates of varying average diameter which were filtered, produce results in excess of any filtering capacity of known particulate filters of this type. In continuous 100ml aliquot samples taken both upstream and downstream of an in-line inventive filter, the following chart indicates the effectiveness of essentially complete filtration, especially as the particulate size is above about 60-70 microns. These test followed test procedure ISO 16889.

Particles/100 ml at: (in microns)

| Time, | | | | | | | | | |
|---|---|---|---|---|---|---|---|---|---|
| min | Port | <40 | <50 | <60 | <70 | <80 | <90 | <100 | <120 |
| 2 min | Upstream | 1210 | 583 | 296 | 187 | 132 | 95 | 75 | 46 |
| | Downstream | 5 | 1 | 1 | 1 | 0 | 0 | 0 | 0 |
| | BETA | 242 | 583 | 296.0 | 187.0 | 132.0 | 95.0 | 75.0 | 46.0 |
| 20% | Upstream | 1353 | 634 | 352 | 232 | 154 | 115 | 91 | 53 |
| | Downstream | 3 | 0 | 0 | 0 | 0 | 0 | 0 | 0 |
| | BETA | 451 | 632 | 352.0 | 232.0 | 154.0 | 115.0 | 91.0 | 53.0 |
| 30% | Upstream | 2723 | 1303 | 730 | 472 | 328 | 245 | 187 | 93 |
| | Downstream | 4 | 2 | 1 | 0 | 0 | 0 | 0 | 0 |
| | BETA | 681 | 652 | 730.0 | 472.0 | 328.0 | 245.0 | 187.0 | 93.0 |
| 40% | Upstream | 2191 | 1045 | 557 | 350 | 254 | 194 | 150 | 89 |
| | Downstream | 5 | 2 | 1 | 0 | 0 | 0 | 0 | 0 |
| | BETA | 438 | 523 | 557.0 | 350.0 | 254.0 | 194.0 | 150.0 | 89.0 |
| 50% | Upstream | 1593 | 790 | 483 | 313 | 240 | 181 | 142 | 86 |
| | Downstream | 2 | 0 | 0 | 0 | 0 | 0 | 0 | 0 |
| | BETA | 797 | 790 | 483.0 | 313.0 | 240.0 | 181.0 | 142.0 | 86.0 |
| 60% | Upstream | 3423 | 1673 | 972 | 633 | 448 | 333 | 253 | 152 |
| | Downstream | 7 | 1 | 0 | 0 | 0 | 0 | 0 | 0 |
| | BETA | 489 | 1673 | 972.0 | 633.0 | 448.0 | 333.0 | 253.0 | 152.0 |
| 70% | Upstream | 3337 | 1629 | 933 | 620 | 435 | 334 | 254 | 144 |
| | Downstream | 8 | 2 | 0 | 0 | 0 | 0 | 0 | 0 |
| | BETA | 417 | 815 | 933.0 | 620.0 | 435.0 | 334.0 | 254.0 | 144.0 |
| 80% | Upstream | 3526 | 1775 | 1040 | 663 | 457 | 356 | 290 | 156 |
| | Downstream | 11 | 0 | 0 | 0 | 0 | 0 | 0 | 0 |
| | BETA | 321 | 1775 | 1040.0 | 663.0 | 457.0 | 356.0 | 290.0 | 156.0 |
| 90% | Upstream | 3460 | 1716 | 959 | 642 | 452 | 347 | 258 | 153 |
| | Downstream | 7 | 1 | 0 | 0 | 0 | 0 | 0 | 0 |
| | BETA | 494 | 1716 | 959.0 | 642.0 | 452.0 | 347.0 | 258.0 | 153.0 |
| 100% | Upstream | 3482 | 1681 | 975 | 649 | 456 | 331 | 251 | 158 |
| | Downstream | 5 | 1 | 0 | 0 | 0 | 0 | 0 | 0 |
| | BETA | 696 | 1681 | 975.0 | 649.0 | 456.0 | 331.0 | 251.0 | 158.0 |
| | AVG BETA | 503 | <1084 | <730 | <476 | <336 | <253 | <195 | <113 |

For a filter having a diameter of about 2 inches in diameter, in a single pass through, where the particle count of a 100 ml aliquot taken at points in the in-line stream above, i.e., upstream, and below, i.e., downstream, of the filter mechanism, shows particle counting data have been collected as follows:

Particles/100 ml: (in microns)

| Net | | | | | | | | |
|---|---|---|---|---|---|---|---|---|
| DP, | | | | | | | | |
| psid | Port | 10 | 20 | 30 | 40 | 50 | 60 | 70 |
| 3.5 | Upstream | 20781 | 4365 | 2899 | 1669 | 872 | 517 | 588 |
| | Downstream | 16546 | 477 | 60 | 9 | 2 | 0 | 0 |
| | BETA | 1.3 | 9.2 | 48.3 | 185.4 | 436.0 | <517 | <588 |
| | Efficiency | 20.4 | 89.1 | 97.9 | 99.5 | <99 | <99 | <99 |

The embodiments of filters 10, 120 and 122 also provide significant additional benefits because of its structure. Because of the fine thread construction of the metal fibers, the surface area of the metal exposed to the passing fluid far exceeds the surface area to volume ratio of the prior art chip type microbial treatment systems, for example, that described and illustrated in aforementioned U.S. Pat. No. 5,198,118, which require a significantly greater amount of volume, and thus, of weight of the brass or other metal chips to produce the same anti-microbial effect as the filter material made according to the present invention. This ability to provide the bacteriocidal function in less volume provides several benefits, including the cost reduction in the procurement of metal, the reduced volume requirements permitting better in-line placement of a circulating fluid, easier replacement procedures, etc.

Another significant advantage, not provided by the prior art systems, is the ability to also filter out particulate chips or other solid impurities that may become entrained in the recirculating fluid, thereby omitting the need for a separate filtering mechanism. This inventive type of filter 10, 120,122 is especially useful in applications in which solid particulates are naturally expected, for example, in an industrial application for cooling fluid in a milling machine where metallic chips are entrained in the coolant, or an air conditioning system, in which the cooling fluid is exposed to the elements and can attract solid particulates, such as insects.

The ability to filter solid particulates of various sizes by the inventive device has been established by testing using filter material made according to the present invention under controlled conditions and utilizing known efficiency standards, for example ASTMF 795 and ISO 16889. In most cases, filter materials, having a thickness of between 2″ to 2.5″ in various fluid materials, for example, water and H 5606 oil, flowing at different rates, and having solid particulates of different sizes entrained therein.

In the majority of cases for a single flow through, each of the inventive filters showed a filtering efficiency of over 50% for particles having a diameter between 10 and 100 microns, with the filtering efficiency for particles over 30 microns being close to 100%. The following table shows the filtering efficiency of three separate filters, two of which are made in accordance with this invention, indicating the ability to produce filters having a significant filtering efficiency. The particulates that were injected into the fluids as contaminants were generally a sieved test dust with ceramic spheres.

Particles/100 ml at: (in microns)

| | Net DP, | | | | | | | | |
|---|---|---|---|---|---|---|---|---|---|
| Sample | psid | Port | 40-50 | 50-60 | 60-70 | 70-80- | 80-90 | 90-100 | <100 |
| 2″ Steel | 0.4 | Upstream | 12095 | 7411 | 5028 | 3232 | 2017 | 1141 | 1141 |
| | | ownstream | 4302 | 2162 | 1201 | 591 | 288 | 153 | 80 |
| | | fficiency | 64.4 | 70.8 | 76.1 | 81.7 | 85.7 | 86.6 | 93.0 |

Note:
2″ dia. steel filter is not straight-possible seal leak due to that feature.

| | Net DP, | | | | | | | | |
|---|---|---|---|---|---|---|---|---|---|
| Sample | psid | Port | 10-20 | 20-30 | 30-40 | 40-50 | 50-60 | 60-70 | <70 |
| 2″ Brass | 0.7 | Upstream | 76067 | 12423 | 5250 | 2647 | 1579 | 956 | 1157 |
| | | Downstream | 36629 | 1712 | 174 | 28 | 6 | 0 | 0 |
| | | fficiency | 51.8 | 86.29 | 96.7 | 98.9 | 99.6 | <99.9 | <99.9 |
| 2.5″ Brass | 0.4 | Upstream | 85673 | 13990 | 6152 | 3147 | 1783 | 1081 | 1312 |
| | | Downstream | 35106 | 1397 | 69 | 2 | 1 | 1 | 0 |
| | | Efficiency | 59.0 | 90.0 | 98.9 | 99.9 | 99.9 | 99.9 | <99.9 |

Tests were also performed in a recirculating fluid stream to text for solid particulate filtration efficiency, and unexpected results were obtained that showed good filtration and also, as indicated above, simultaneously provided a bacteriocidal capacity. The filtration results, showing the number of solid particles of varying average diameter which were filtered, produce results in excess of any filtering capacity of known particulate filters of this type. In continuous 100ml aliquot samples taken both upstream and downstream of an in-line inventive filter, the following chart indicates the effectiveness of essentially complete filtration, especially as the particulate size is above about 60-70 microns.

Filter ID:2.5″ Brass

Particle counts and filtration ratio:

Particles/100 ml at: (in microns)

| Time, | | | | | | | | | |
|---|---|---|---|---|---|---|---|---|---|
| min | Port | <40 | <50 | <60 | <70 | <80 | <90 | <100 | <120 |
| 2 min | Upstream | 1210 | 583 | 296 | 187 | 132 | 95 | 75 | 46 |
| | Downstream | 5 | 1 | 1 | 1 | 0 | 0 | 0 | 0 |
| | BETA | 242 | 583 | 296.0 | 187.0 | 132.0 | 95.0 | 75.0 | 46.0 |
| 20% | Upstream | 1353 | 634 | 352 | 232 | 154 | 115 | 91 | 53 |
| | Downstream | 3 | 0 | 0 | 0 | 0 | 0 | 0 | 0 |
| | BETA | 451 | 632 | 352.0 | 232.0 | 154.0 | 115.0 | 91.0 | 53.0 |
| 30% | Upstream | 2723 | 1303 | 730 | 472 | 328 | 245 | 187 | 93 |
| | Downstream | 4 | 2 | 1 | 0 | 0 | 0 | 0 | 0 |
| | BETA | 681 | 652 | 730.0 | 472.0 | 328.0 | 245.0 | 187.0 | 93.0 |
| 40% | Upstream | 2191 | 1045 | 557 | 350 | 254 | 194 | 150 | 89 |
| | Downstream | 5 | 2 | 1 | 0 | 0 | 0 | 0 | 0 |
| | BETA | 438 | 523 | 557.0 | 350.0 | 254.0 | 194.0 | 150.0 | 89.0 |
| 50% | Upstream | 1593 | 790 | 483 | 313 | 240 | 181 | 142 | 86 |
| | Downstream | 2 | 0 | 0 | 0 | 0 | 0 | 0 | 0 |
| | BETA | 797 | 790 | 483.0 | 313.0 | 240.0 | 181.0 | 142.0 | 86.0 |
| 60% | Upstream | 3423 | 1673 | 972 | 633 | 448 | 333 | 253 | 152 |
| | Downstream | 7 | 1 | 0 | 0 | 0 | 0 | 0 | 0 |
| | BETA | 489 | 1673 | 972.0 | 633.0 | 448.0 | 333.0 | 253.0 | 152.0 |
| 70% | Upstream | 3337 | 1629 | 933 | 620 | 435 | 334 | 254 | 144 |
| | Downstream | 8 | 2 | 0 | 0 | 0 | 0 | 0 | 0 |
| | BETA | 417 | 815 | 933.0 | 620.0 | 435.0 | 334.0 | 254.0 | 144.0 |
| 80% | Upstream | 3526 | 1775 | 1040 | 663 | 457 | 356 | 290 | 156 |
| | Downstream | 11 | 0 | 0 | 0 | 0 | 0 | 0 | 0 |
| | BETA | 321 | 1775 | 1040.0 | 663.0 | 457.0 | 356.0 | 290.0 | 156.0 |
| 90% | Upstream | 3460 | 1716 | 959 | 642 | 452 | 347 | 258 | 153 |
| | Downstream | 7 | 1 | 0 | 0 | 0 | 0 | 0 | 0 |
| | BETA | 494 | 1716 | 959.0 | 642.0 | 452.0 | 347.0 | 258.0 | 153.0 |
| 100% | Upstream | 3482 | 1681 | 975 | 649 | 456 | 331 | 251 | 158 |
| | Downstream | 5 | 1 | 0 | 0 | 0 | 0 | 0 | 0 |
| | BETA | 696 | 1681 | 975.0 | 649.0 | 456.0 | 331.0 | 251.0 | 158.0 |
| | AVG BETA | 503 | <1084 | <730 | <476 | <336 | <253 | <195 | <113 |

For a filter having a diameter of about 2 inches in diameter, in a single pass through, where the particle count of a 100 ml aliquot taken at points in the in-line stream above, i.e., upstream, and below, i.e., downstream, of the filter mechanism, shows particle counting data have been collected as follows:

Particles/100 ml: (in microns)

| Net | | | | | | | | |
|---|---|---|---|---|---|---|---|---|
| DP, | | | | | | | | |
| psid | Port | 10 | 20 | 30 | 40 | 50 | 60 | 70 |
| 3.5 | Upstream | 20781 | 4365 | 2899 | 1669 | 872 | 517 | 588 |
| | Downstream | 16546 | 477 | 60 | 9 | 2 | 0 | 0 |
| | BETA | 1.3 | 9.2 | 48.3 | 185.4 | 436.0 | <517 | <588 |
| | Efficiency | 20.4 | 89.1 | 97.9 | 99.5 | <99 | <99 | <99 |

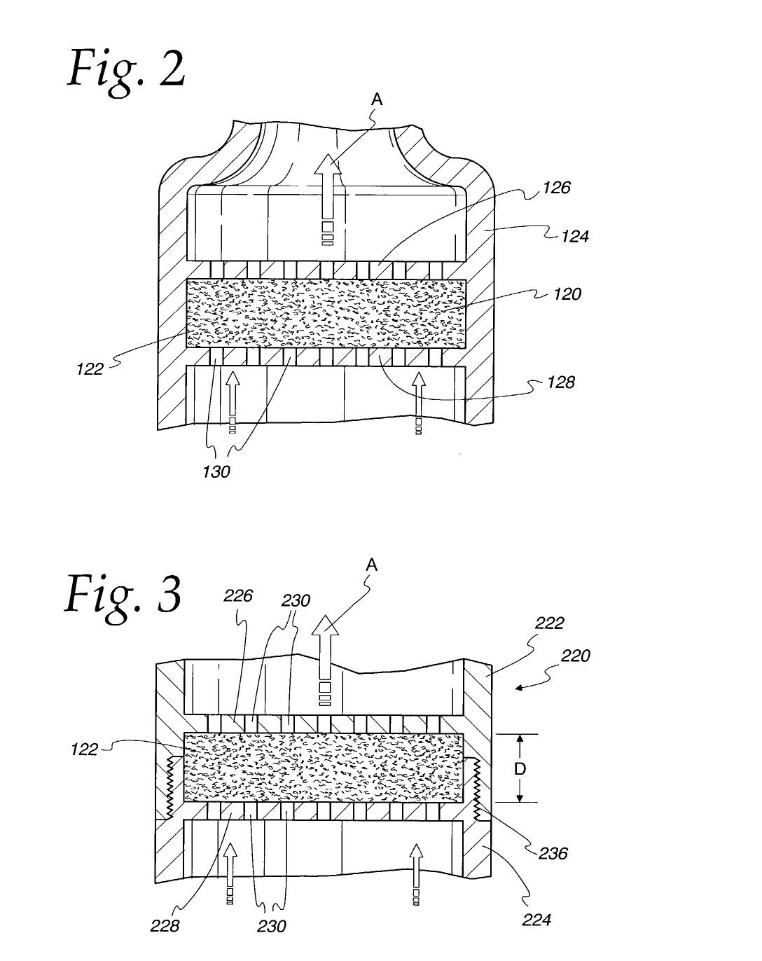

In a first alternative embodiment, shown in cross section in FIG. 2 a metal fiber wool insert 120 is made by overlaying several layers of metal wool fibers over each other to provide a filter pad 122 mass having a desired profile shape that corresponds to a receptacle for enclosing and retaining the metal wool pad insert.

The receptacle may be a single container comprised of longitudinal walls 124, shown in FIG. 2 as being cylindrical, but in essence may take any enclosed or sealed shape. A perforated wall 126 extends essentially transverse to the longitudinal extension of walls 124, the perforated wall 126 extending essentially perpendicular to a fluid flowing through the container defined by walls 124, shown by Arrow A.

A second transverse wall 128 is shown as being perforated, that is having perforations 130, but this perforated wall 128 is an optional. For example, either or both walls may be replaced by a perforated screen (not shown) or any other solid porous retaining member that contains the filter pad 122 in position so as to contain complete fluid flow to a path only through pad 122.

Thus, it is preferable that two solid porous transverse walls 126, 128 be used that not only contain the fluid flow in the desired path, but also provide the ideal compression between the surfaces contacting the pad 122 to produce a filter retaining an appropriate density for filtering out the particulates entrained in the flowing fluid.

Another alternative embodiment 220 is shown in cross-section in FIG. 3. The embodiment of FIG. 3 is similar to the form of a stand alone fluid filter FIG. 2, with the exception that the filter chamber is formed in two separate sections of an in-line tube that may be attached at either of its ends, an inflow end and an outflow end, in-line to a fluid recycling system. In the filter embodiment 220 a pair of corresponding halves of a longitudinal receptacle are provided so that joining of the two halves produces a confining container for retaining a metal fiber wool pad 122, as in the embodiment of filter 120 shown in FIG. 2. Each half of the receptacle 270 includes a longitudinal wall 222, 224, respectively, and an essentially transverse wall 226, 228, disposed adjacent the longitudinal end of each longitudinal wall 222, 224. As can be seen from FIG. 3, the transverse wall 226 is inset a short distance from the end lip of longitudinal wall 222 and wall 228 is inset from the end lip of wall 224. The transverse walls 226, 228 include perforations 230, which permit fluid to flow through the receptacle 220 in the direction of Arrow A.

The two halves of the receptacle are shown to be connected by a threaded connection 236, but other types of attachments or connections are possible, such as a pivotable latch, a snap fit or other appropriate type of connection (not shown). The significant feature of the connection method is the ability to accurately and precisely provide a dimension D, that is the longitudinal dimension between the inner surfaces of the transverse perforated walls 226, 228 so that the metal fiber wool pad insert 122 is precisely compressed to provide the required density of the fibers, thereby producing an optimal filtering capability for particulates of a specified size. Accordingly, the feature for which close tolerances are required are the end prints of screw thread connections 236, which must engage when the optimal distance D is reached.

Preferably, the metal is a brass wool insert and is retained in place by two perforated metallic sieves or screens 226, 228 that compress the brass wool to a desired compression and density range so as to provide optimal filtering characteristics. The preferable method of forming the insert is by needle punching the brass wool fibers to achieve the desired density and porosity, and then compressing the known thickness of insert 122 to achieve the desired density.

The embodiment of FIG. 2 is in the form of a stand alone fluid filter that may be attached at either of its ends, an inflow end and an outflow end, in-line to a fluid recycling system, as described with reference to the embodiments above. The fluid filter is placed within the receptacle chamber between two perforated metallic sieves 226, 228 so that fluid flowing through the chamber is forced to pass through the brass wool filter material. The filter provides adequate filtering capacity to maintain a minimal pressure drop across the filter chamber, and the density and porosity of the filter material is maintained to a level conducive with the requirement that the fluid is permitted to pass through the filter.

The brass wool insert is manufactured as a replacement part for inserting into the tube ends, so that when the housing portions are attached to each other by a an appropriate means, such as a threaded connection, as shown, the compression pressure produced by the two perforated sieve plates is sufficient to cause the brass wool material to achieve the desired density and porosity. The fluid flowing through the chamber is forced to pass through the brass wool filter material to clean it of bacteria. One advantage of the fluid filter 220 is that the insert metal wool pad 122 is replaceable, when desired or when the filtering capacity is reached.

This invention has been described with reference to the above disclosed embodiments. Modifications and alterations of the disclosed and illustrated embodiments are within the ability of persons having ordinary skill in the filtering industry, and this invention is not intended to be limited to the description of only the disclosed embodiments, the invention being limited only by the following claims and equivalents thereof.

What is claimed is:

1. A method of filtering flowing fluid containing undesirable particulates and bacterial constituents so as to remove said particulates and reduce said bacterial constituents therefrom, said method comprising:
a) providing an enclosed channel for the fluid to flow therethrough; and
b) passing said fluid flow through a filter material, disposed within the channel and in the path of the fluid flow, wherein the filter material comprises a metal alloy consisting primarily copper and zinc, and said material further comprises a metal fiber wool consisting of metal fibers having an average diameter in a range of from 12 microns to 150 microns, whereby said fluid containing said bacterial constituents contacting with the fibers of the metal fiber wool provides a bactericide effect and further inhibits the propagation of bacteria and inhibits particulates from flowing through said filter material.

2. The method of filtering according to claim 1, in which the flowing fluid is a recirculating fluid that passes through the filter material multiple times during recirculation.

3. The method of filtering according to claim 1, in which the metal fiber wool is compressed to a density between about 0.4 and about 2.5 g/cm³.

4. The method of filtering according to claim 1, in which the metal fiber wool is compressed to a density between about 0.5 and about 1.5 g/cm³.

5. The method of filtering according to claim 1, in which the metal fiber wool is compressed to a density approximately 0.8 g/cm³.

6. The method of filtering according to claim 1, in which the filter is a radial-flow fluid filter.

7. A radial-flow fluid filter having a production tubing of a predetermined outer diameter D1, comprising:
a length L of multi-perforate pipe being much larger than D1, the multi-perforate pipe having an outer diameter corresponding to the diameter of a surrounding filter housing;
a plurality of overlapping layers of at least one strip of fibrous metal filter wool wound around the exterior of the length L of multi-perforate pipe, so that adjacent layers are aligned with each other, said metal filter wool comprising a metal containing copper (Cu); and
a multi-perforate tubular shell fitting tightly around the outermost layer of the copper containing fibrous metal wool.

8. A radial-flow fluid filter according to claim 7 and further comprising a multi-perforate shell disposed around the outermost layer of metal wool, the shell having an inner diameter approximately equal to the outer diameter D2 of the outermost layer of wool and a tubular metal mesh encompassing the exterior of the pipe between the pipe and the innermost layer of metal wool.

9. A radial-flow fluid filter according to claim 8, in which the tubular mesh is a woven mesh of stainless steel.

10. A radial-flow fluid filter according to claim 7, in which the metal of the fiber wool layers is a brass alloy further comprising between 50 to 90 weight % copper and from 10 to 50 weight % zinc.

11. A radial-flow fluid filter according to claim 7, and further comprising:
a tubular metal mesh encompassing the exterior of the pipe, between the pipe and at least some of the layers of metal wool.

12. An in-line fluid flow filter for a fluid channel comprising:
a) a fluid channel providing for fluid flow between openings in said channel;
b) a fluid filter disposed in the path of said fluid flow of said channel, said fluid filter being made from a filter material comprising a metal fiber wool of a metal alloy, said metal alloy consisting primarily copper and zinc and being metal fibers having an average diameter in a range of from 12 microns to 150 microns, compressed to a predetermined density in a range between 0.4 g/cc to 2.5 g/cc.

13. The in-line fluid flow filter according to claim 12, in which the metal fiber wool is compressed to a density between about 0.5 and about 1.5 g/cm³.

14. The in-line fluid flow filter according to claim 12, in which the metal fiber wool is compressed to a density approximately 0.8 g/cm³.

15. The in-line fluid flow filter according claim 12 wherein said metal alloy is a brass alloy further comprising between 50 to 90 weight % copper and from 10 to 50 weight % zinc.

16. The in-line fluid flow filter according claim 12 wherein said metal alloy is a brass alloy further comprising trace elements as impurities.
